(19) United States
(12) Patent Application Publication
(10) Pub. No.: US 2003/0174357 A1
(43) Pub. Date: Sep. 18, 2003

(54) Printer, printer controller, and method of proofing a document

(76) Inventors: Samuel M. Lester, Boise,, ID (US); Jimmy Sfaelos, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/099,484

(22) Filed: Mar. 12, 2002

(51) Int. Cl. G06F 15/00; B41J 1/00; H04N 1/00

(52) U.S. Cl. 358/1.15; 358/402

(57) ABSTRACT

A controller for a printer is provided, being accessible using a web browser, configured to render an image of at least a portion of a print job, prior to printing, in a format viewable on a web browser; receive instructions from a user, via a web browser, as to whether or not to proceed with printing of the print job; and effect printing of the print job in response to receiving an instruction to do so via the web browser. Also provided is a printer capable of generating a proof image or images, viewable via a web browser, of a document file prior to printing. Further provided is a method of proofing a document prior to printing by accessing a printer web page using a web browser.

### FIELD OF THE INVENTION

The invention relates to user interfaces for image rendering devices. More particularly, the invention relates to embedded web functionality for printer access, control, document management and document previewing.

### BACKGROUND OF THE INVENTION

Printers and other devices including embedded web servers are known in the art. The embedded web server allows control of the printer using a web browser interface that is easy to use and familiar to users, since they use the same type of interface for browsing the Internet. Embedded web servers are presently used in various existing products including, for example, the model 4100N printer available from the assignee of the present invention.

The web interface allows control of various operational features of a printer, such as features that could be controlled using print driver software or using a keypad and display on the printer itself. To use the web interface, a user connects a web-enabled printer to a personal computer (either directly or via a network), and enters a predetermined URL (Uniform Resource Locator) or web address associated with the printer, using a web browser (e.g., Mozilla (TM), Netscape (TM), or Internet Explorer (TM)), to bring up a web page for use in controlling the printer. Attention is directed to the following U.S. Patents, assigned to the assignee of the present invention and incorporated herein by reference: U.S. Pat. No. 6,170,007 to Venkatraman et al.; U.S. Pat. No. 6,139,177 to Venkatraman et al.; and U.S. Pat. No. 5,956,487 to Venkatraman et al.

Color management is a term used to describe the range of functions that a hard copy device must perform to render a color image onto media. Color management functions include interpretation and transformation of an electronic document file into machine control signals required to carry out incorporation of the color-rendering resources, such as ink or toner, onto print media, so as to produce a printed version of the document file. Fidelity of the printed image with what was intended by the user depends on a number of factors, including: the appearance of the file image on a monitor screen during file creation and/or editing prior to printing, the depth of image information within the electronic file sent to the printer, the nature of the color management system used within the printer, and other factors.

Most color devices (i.e., printers, digital cameras, monitors, etc.) have some color conversion or color management system in it. Color users (digital camera users, print users, photo layout advertising, newspaper/magazine editors, web surfers, etc.) expect their output to have correct color. As people pay more dollars for output, their expectations for accuracy increase. For example, if a significant number of flyers are printed having the color orange where yellow should be, there would be uncertainty and disagreement as to whether the printing service provider or the client is responsible for the associated cost of the error. This sort of problem is a significant issue in the printing industry.

### SUMMARY OF THE INVENTION

The invention provides a method and apparatus for a preview after device rendering but before placement on the media. This permits user verification that rendered colors agree with expectations, and provides an opportunity to verify other aspects of document appearance prior to printing.

Another aspect of the invention provides for previewing an image or images of a document file, as rendered by an Electronic Web Server-equipped printer, by accessing a web page generated by the printer. A range of other user-accessible controls and options may be included in such printers. For example, manipulation of color management parameters may be performed through access to the corresponding Electronic Web Server-generated web page(s).

In one embodiment, access to these functions is available through a network such as, but not limited to, the Internet, an intranet, a large scale commercial network, USB, USB 2.0, IEEE 1394, or a home-based network.

One aspect of the invention provides an option to “paperless proof” (preview) at least part of a document file prior to printing some or all of that file. The concept of previewing a document (i.e., by way of a computer monitor) substantially as it will appear in printed form is referred to as “What-You-See-Is-What-You-Get” (WYSIWYG) in the computer-related arts. The paperless proof function provides a WYSIWYG preview image having a high degree of fidelity with the printed hardcopy ultimately produced.

One aspect of the invention provides a controller for a printer, accessible using a web browser, configured to render an image of at least a portion of a print job, prior to printing, in a format viewable on a web browser; receive instructions from a user, via a web browser, as to whether or not to proceed with printing of the print job; and effect printing of the print job in response to receiving an instruction to effect printing from the user, via the web browser.

Another embodiment of the invention provides a printer comprising a housing; a print mechanism supported in the housing; a controller coupled to the print mechanism to control the print mechanism; and a web server coupled to the controller and configured to render a proof image of at least a portion of a print job, prior to printing, in a format viewable on a web browser, to receive instructions from a user, via a web browser, as to whether or not to proceed with printing of the print job, and to effect printing of the print job in response to receiving an instruction to proceed with printing via the web browser.

In yet another aspect of the invention, a method of proofing a print job before printing is provided, comprising providing a printer with a controller configured to be accessible using a web browser; rendering an image of at least a portion of a print job, prior to printing, in a format viewable on a web browser, using the controller; receiving instructions from a user, via a web browser, as to whether or not to proceed with printing at least a portion of the print job; and printing the print job in response to receiving an instruction to do so via the web browser.

Still another aspect of the invention provides a controller for a printer, accessible using a web browser, comprising means for rendering an image of at least a portion of a print job, prior to printing, in a format viewable on a web browser; means for receiving instructions from a user, via a web browser, as to whether or not to proceed with printing of the print job; and means for effecting printing of the print job in response to receiving an instruction to do so via the web browser.

Other features and advantages of the present invention will be apparent from the detailed description that follows.

### BRIEF DESCRIPTION OF THE DRAWINGS

FIG. 1 illustrates a hardware block diagram of a printer with embedded web server functionality.

FIG. 2 illustrates an exemplary web page for a printer with embedded web access capability.

FIG. 3 illustrates an exemplary web page from which various paperless proof options can be selected or changed.

FIG. 4 shows an exemplary proof image web page.

FIG. 5 is a flowchart illustrating an example sequence of performing a paperless proof.

FIG. 6 is a block diagram illustrating the inter-connection of various devices used in document file creation and printing.

### DETAILED DESCRIPTION OF THE INVENTION

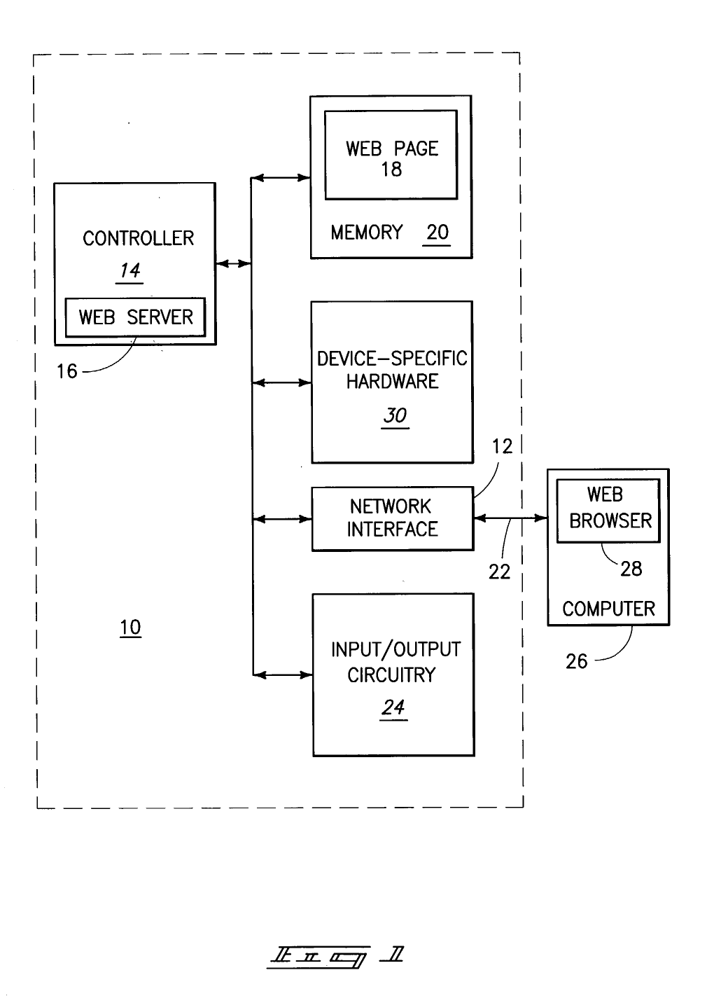

FIG. 1 shows a printer 10 with embedded web access functionality that provides printer-specific user interface functions. The printer 10 includes a network interface 12 and a controller 14 defining a web server 16. The network interface 12 enables communication via a communication path 22. The web server 16 provides web server functions to web clients (e.g., computers or terminals having web browser software) via the communication path 22. The web server 16 provides web server functions according to the Hyper-Text Transfer Protocol (HTTP).

The web server 16 receives HTTP commands through the network interface 12 that specify a predetermined Universal Resource Locator (URL) for the printer 10. The HTTP commands may be used by web clients to read information from the printer 10 such as status information. The HTTP commands may also be used to transfer information to the printer 10 such as information that controls the functions or operating states of the printer 10. The printer 10 includes memory 20 that contains files which, when assembled, define a web page 18. Though the files would not be assembled in the memory 20, the files are collectively referred to as web page 18, for simplicity. In response to an HTTP command targeted for the printer 10, the web server 16 interacts with memory 20 to generate a web page 18, for a client, that defines a set of user interface functions for the printer 10. The web page 18 is a Hypertext Markup Language (HTML) page. The network interface 12 transfers the web page 18 to a requesting HTTP client via the communication path 22.

In addition, the web page 18 may contain one or more URLs that specify additional web pages located within the printer 10. The web page 18 may also contain one or more URLs that specify additional web pages located elsewhere, i.e. external to the printer 10.

Though the network interface 12 typically includes a network connector, the communication path 22 may be realized by a wide variety of communication mechanisms including local area networks, telephone lines, mobile telephone links, serial communication links, parallel communication links, power line communication links, and radio and infrared communication links. The communication path 22 may also be a connection to the Internet.

The printer 10 further includes input/output circuitry 24 including, for example, a parallel port, for direct connection to computer. The web server functionality is embedded into the printer 10 by providing software or firmware for the controller 14 and by utilizing space available in the memory 20 and by using the existing input/output circuitry 24 or network interface 12 to transfer HTML files.

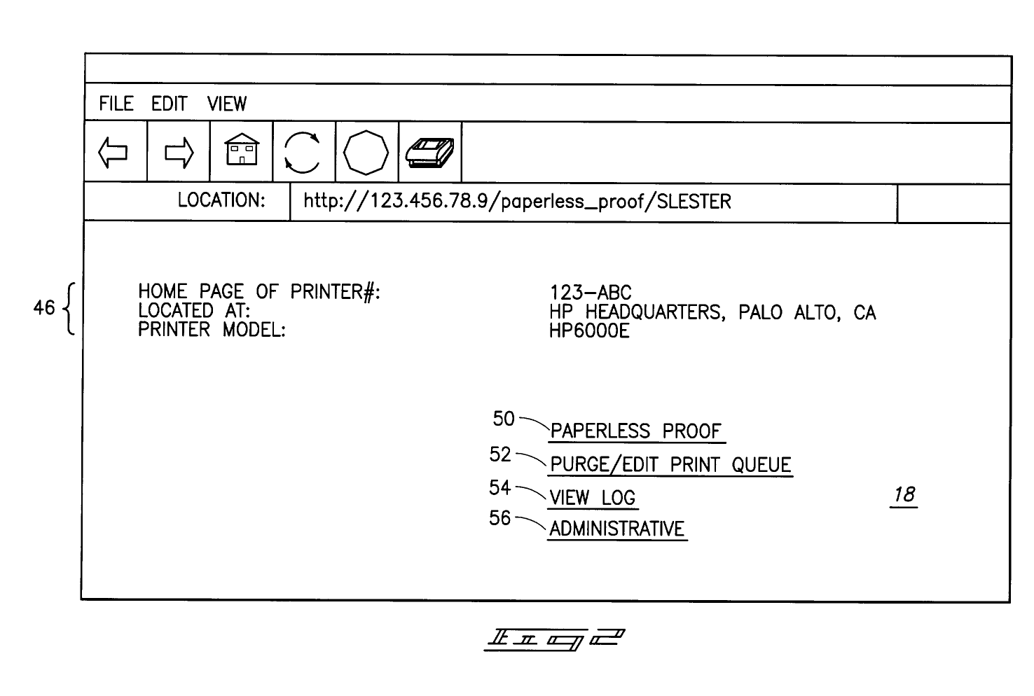

The information for the web page 18 may be periodically updated by the controller 14 and stored in HTML format in the memory 20. In such case, the controller 14 reads the web page 18 from the memory 20 in response to the HTTP command and transfers the web page 18 to a web browser of a client (not shown in FIG. 2).

In one embodiment, the web page 18 or other web pages (not shown) of the printer 10 may be accessed by any web client on the Internet, such as computer 26 having a web browser 28. The printer 10 may require authentication, however. The web browser 28 enables the displaying of visual objects including text, images, multimedia objects, and graphical user interface objects, and can receive user inputs such as selection of radio buttons, check boxes, input of text, or other items.

The web browser 28 may be embodied in a computer 26 that executes web browser software. Such a computer with web browser functionality may be realized by any one of a variety of available computer system platforms including Windows platforms, Macintosh platforms, Unix platforms as well as any other platform capable of executing web browser software that provides HTTP client functions and that renders HTML files. The web browser 28 may also be embodied in a variety of other devices that provide HTTP client functions and that render HTML files. Such devices include specialized hardware designed for television or telephone systems as well as low cost web browser devices and network computers or terminals.

In a typical operation of printer 10, a user accesses and controls the user interface functions of the printer 10 using the web browser 28. The user enters a URL corresponding to the printer 10 into the web browser 28. In response, the web browser 28 transfers an HTTP command which includes the entered URL over the communication path 22. The printer 10 receives the HTTP command via the communication path 22 and recognizes the URL contained therein. Appropriate action on the part of printer 10 is then taken in response to the received HTTP command. Possible such actions are detailed hereafter.

FIG. 2 illustrates an example web page 18 for the printer 10. The web page 18 is rendered on the computer 26 by the web browser 28 in response to the browser requesting the printer's web page 18. The web page 18 includes, for example, any desired text or graphics 46, and hyperlinks 50-56.

The hyperlinks 50-56 direct the web browser 28 to other web pages for various printer support functions, for example, and include hyperlink 50 “Paperless Proof”, which may be selected by the user with a mouse or other selection device to initiate the paperless proof option. Various other web pages (if any) which a manufacturer may elect to provide are accessible through hyperlinks 52-56.

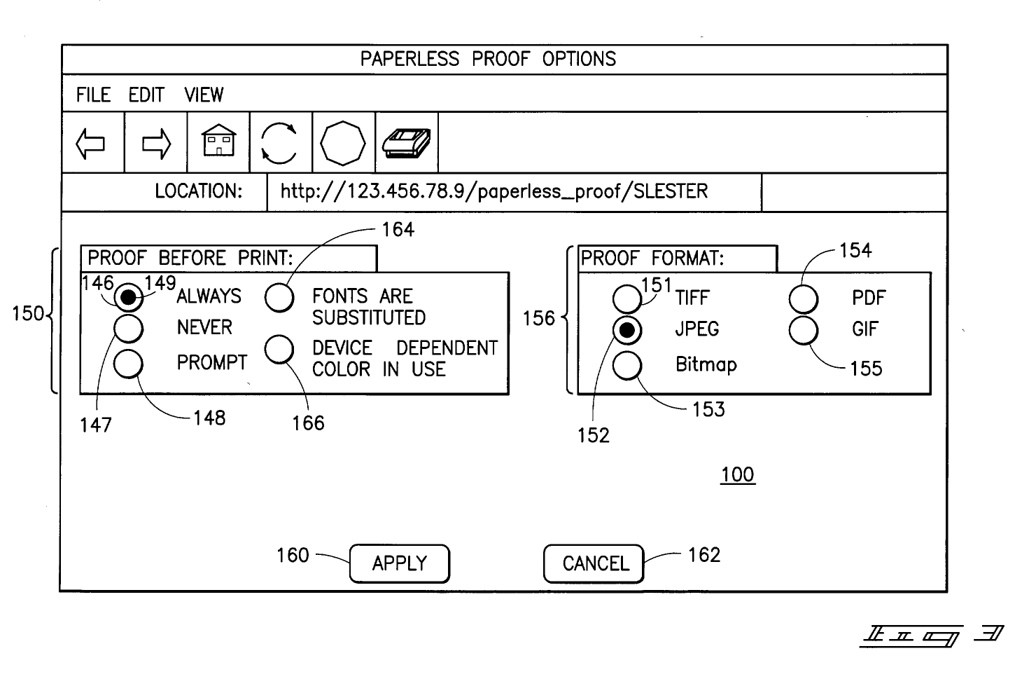

FIG. 3 illustrates one embodiment of a proof options web page 100, accessible by way of the paperless proof command hyperlink 50 on web page 18. A command button (not shown) on web page 18 may alternatively be used to access web page 100. In one embodiment, the functions of page 100 are accessible on page 18, and page 100 is omitted. Using the web page 100, a user can select the status of the “paperless proof” option using radio buttons 146-148 within group 150. The user may also select the format of the proof image file (e.g., TIFF, JPEG, Bitmap, PDF or GIF) using group 156.

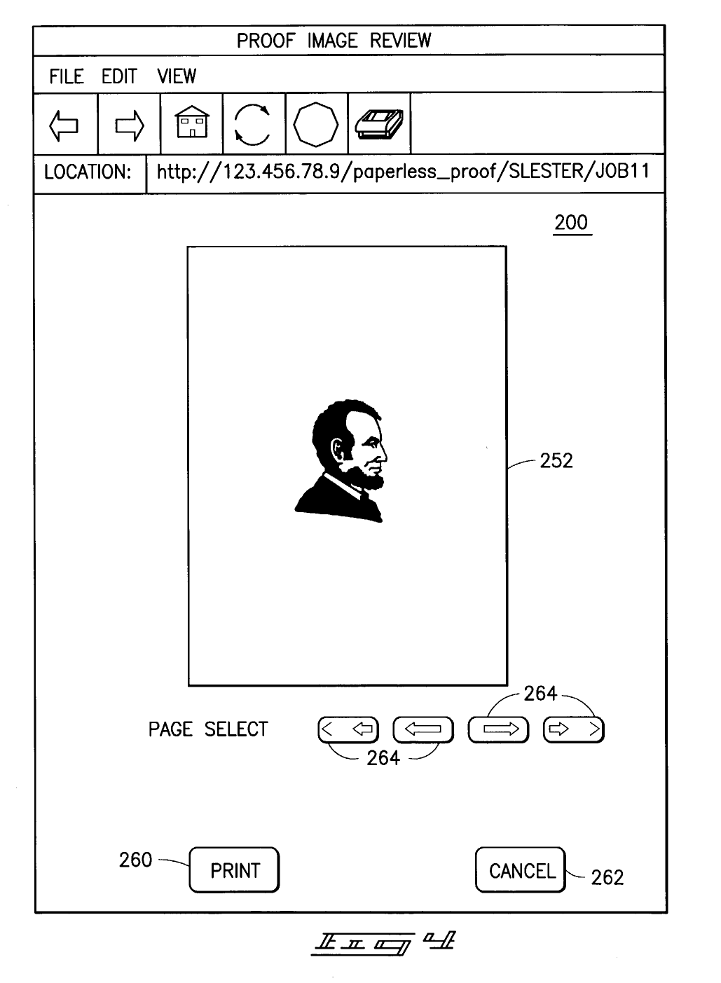

More particularly, using the web page 100, a user can select “paperless proof” to occur always, in response to prompting the user at every print command, or never. As shown in FIG. 3, the “ALWAYS” option has been selected as indicated by the presence of dot 149 within the corresponding radio button 146. Selection of given radio button is performed using a device such as a mouse in conjunction with the web browser 28. If the user selects “ALWAYS” (or “PROMPT” and then elects proofing when prompted) for paperless proof, then in response to each print command (for which the printer 10 is the selected or default printer, for example) the printer 10 generates a proof image such as shown in FIG. 4. If “NEVER” is selected, printing occurs normally when print commands are received, without generation of proof images. The proof images are typically color images. Certain selectable options automatically execute the rest of the paperless proof sequence. As shown in FIG. 3, two such options are the “FONTS ARE SUBSTITUTED” radio button 164 and the “DEVICE DEPENDENT COLOR IN USE” radio button 166. Both radio buttons 164 and 166 affect the final printed appearance of the print job and therefore paperless proofing is always assumed to be desired by the user under either of these selections.

In operation, the user selects the desired options using radio buttons, hyperlinks, check boxes, or other input method. As shown, selection of any given radio button 146-148 or 151-155 within respective selection group 150 or 156 is mutually exclusive of the other radio buttons within that range: for example, selection of the ‘JPEG’ radio button 152 within group 156 has the additional effect of de-selecting the other radio buttons 151 and 153-155 within group 156. A deselected radio button has no dot within it. This exclusive selectivity ensures that logistically inconsistent or ambiguous selections cannot be made by the user. In contrast, radio buttons 164 and 166 are not exclusive, and any combination of these may be selected. Once the options have been selected, the user then applies the selections (saves the selections) using command button 160 by way of a selection device such as a mouse, or cancels and returns to web page 18 using cancel command button 162. The proof options web page 100 just described is exemplary of one possible embodiment. Other embodiments of a proof options web page (not shown) are also possible, having any object type supported by the HTTP and HTML protocols.

FIG. 4 illustrates one embodiment of a proof review web page 200. The web page 200 is generated by web server 16 within the printer 10. A proof image 252 under examination is provided. Proof image(s) 252 may include such text or graphics as would be generated by any document creation software program which would be used with printer 10.

After the user completes the review of the proof image(s) 252, the user may select to print using print command button 260, or cancel the proof sequence using cancel command button 262. Cancellation may, for example, return the user to the software application from which the print command was selected. Other courses of action as a result of cancellation are possible. Examination of proof image 252 is particularly useful in the case of documents having color graphic content, where a number of proof-and-edit iterations may be necessary, each requiring editing the document file and/or adjustment of the printer 10 color management controls to achieve a satisfactory printed result. Optional additional image viewing commands can include, for example, image page selector buttons 264. Using selector buttons 264, the user may selectively page through multiple rendered images, if more than one image has been generated. Other embodiments of a proof review web page are possible.

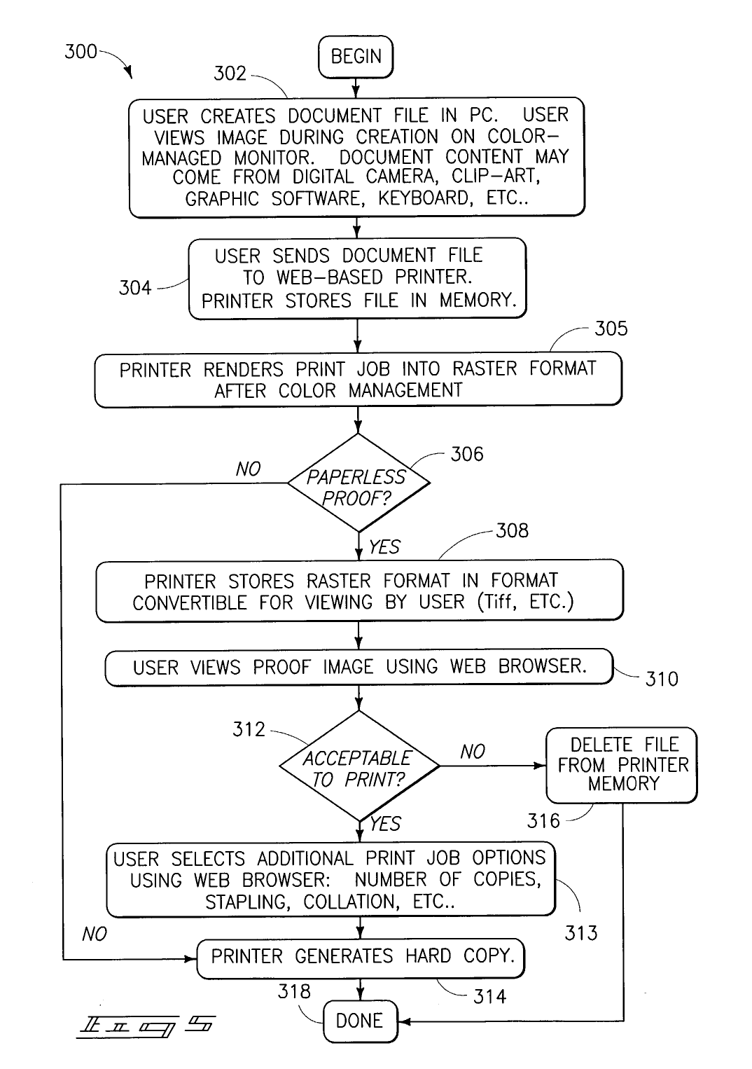

FIG. 5 provides a flowchart 300 to summarize an exemplary paperless proofing sequence as described in the foregoing paragraphs. Step 302 illustrates the beginning step in the process, wherein a user creates and/or modifies a document file by way of a computer. Input to the document may come from a computer keyboard, a computer mouse, a digital camera, a scanner, images and/or text taken from e-mail, or other sources. When the user is ready to print the document, the document file is sent to a printer as shown in step 304. The printer receives the file and stores it in memory. In step 305, color management (e.g. an algorithm or digital circuitry process) is applied to the document file, after which the printer renders the print job into raster format interpretation by performing an interpretation (e.g., a Postscript PCL or XL interpretation). The printer then determines if paperless proofing is desired by the user, as shown in step 306. This determination is made by evaluating the present status of the user's proof before print selection. If the present status is “PROMPT”, then the user is prompted via the printer's web page as to whether or not the present file is to be paperless proofed. If the user responds that proofing is desired (via controls on the web page), or if the present status is “ALWAYS”, than the sequence proceeds to step 308, described below. If the present status is “NEVER”, then the sequence proceeds to step 314, described below.

In step 308, the embedded web server renders the proof images in a format viewable by the user's web browser (i.e., TIFF, JPEG, etc.). The user then views the rendered proof images, in step 310, using the web browser. The user then instructs the printer as shown in step 312, via controls on the web page, whether to print some or all of the document, or to abandon the document file without printing. If the user chooses to print, then the sequence proceeds to step 313, in which the user may select additional options to be applied to the print job. Such options may include specifying the number of copies to print, stapling, collating, etc. After the options of step 313 have been selected, the sequence moves on to step 314, at which point the printer prints the desired portion or entirety of the document. If the user elects to abandon the file without printing, than the document file is deleted from the printer memory as shown in step 316. In either case, the sequence ends at step 318. This sequence 300 represents one possible embodiment of the invention. Other sequences and options are possible.

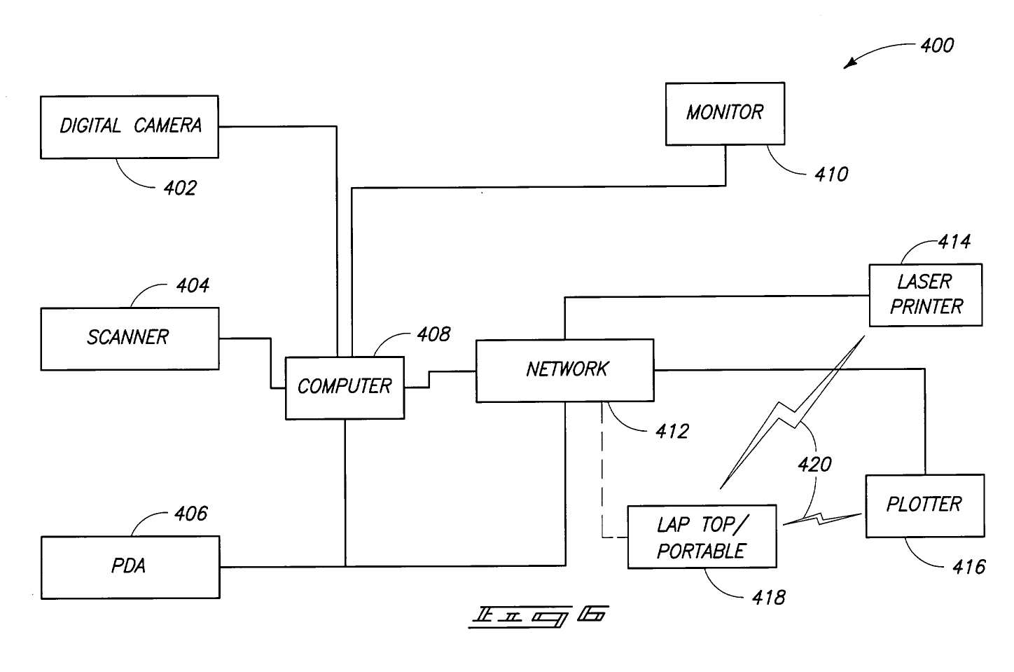

FIG. 6 is a block diagram showing the inter-connection of various device elements or components which may be used in the document file creation and printing. One possible example of a system of components is generally represented by numeral 400. System 400 includes input devices such as digital cameras 402; scanners 404; and/or Personal Digital Assistants (PDA) 406. The digital camera 402, scanner 404, and/or PDA 406 are connected to the computer 408. A monitor 410 is also connected to computer 408. The computer 408 and the PDA 406 are connected to a network 412, which further connects to laser printer 414 and plotter 416. A laptop computer 418, in addition to or instead of computer 408 can communicate with printer 414 and/or plotter 416 by way of wireless link 420, through network 412, or through direct connection. Such wireless linking 420 may be carried out through radio frequency communication, infra-red beaming, etc.

In typical usage, one or more of input devices 402, 404 and/or 406 may be used to provide input to computer 408. Input may include, for example, digital photographs from the camera 402; and/or scanned text or images from the scanner 404. The PDA 406 may provide input such as notes taken by the user during travel; appointment or scheduling information; business expenses; etc. Other kinds of information may also be provided. The computer 408 may be used, in conjunction with monitor 410, to run a host of file creation and manipulation software packages (not shown), such as word processing; spreadsheet; graphic illustration; photographic editing, etc. Any of these may be used to combine and/or alter information from the input devices 402-406, as well as that provided by keyboard (not shown), microphone (not shown), or other mechanism, so as to create an electronic document file using a suitable software application.

Color management functionality incorporated into the monitor 410 generates an image on the monitor screen that represents the document file under creation or review by the computer 408 user. After the user is satisfied with the condition of the document file, and wishes to print or plot the file, or some portion thereof, the document file is routed over the network 412 to the printer 414 or plotter 416. Paperless proofing functionality within the printer 414 or the plotter 416 may be selected by the user to render an image representing the document file. This rendered image or images may be reviewed on the monitor 410 using web browser software (not shown) running on the computer 408. The user may then elect to print (or plot) some or all of the document file using the printer 414 or plotter 416.

A laptop computer 418 may provide similar file creation and manipulation as described for computer 408 above, typically using a built-in monitor to display the document file images. As shown in FIG. 6, the user may transfer a document file from the laptop computer 418 to the printer 414 or the plotter 416 by way of wireless linking 420; generate a rendered image or images using paperless proofing; review the image(s); and elect to print (or plot) some or all of the document file using printer 414 or plotter 416. During this sequence, communications between the laptop computer 418 and the printer 414 or the plotter 416 can be carried out by way of wireless links 420. The laptop computer 418 may also feature color management functionality similar to that described above. Components other than those illustrated in example system 400 may be used, and numerous different system configurations are possible.

The paperless proof function generally involves a user sending a document file to the printer by way of a web browser, of which several different makes and versions are in common use, serving as the software element required to access the functionality of the printer by way of the printer's web page(s). The printer stores the document file in memory after reception. The user then selects the paperless proof option for the file by way of the printer's web page(s). In response, an electronic proof image representing at least a portion of the file is rendered by the embedded web server within the printer, in a pixel graphic format (i.e., JPEG; TIFF; PDF; Bitmap; etc.) selected by the user from those available in the printer. The user then views this proof image on the corresponding printer web page(s), and subsequently selects to print some or all of the file, or selects to cancel the file in printer memory without printing.

The user interface information is packaged using the Hyper-Text Markup Language (HTML) and is transported according to the Hyper-Text Transfer Protocol (HTTP). The HTML and HTTP protocols enable communication with existing web browsers independent of the platform that executes the web browser. The present techniques avoid the need of an industry-wide Application Programming Interface (API) to unify the control and use of equipment.

Furthermore, the embedded web server can cooperate with the color management system of the printer such that the rendered proof images are of high color fidelity with respect to the printed copy. In this way, proofing is possible that is substantially more accurate than the commonly used “print preview” ability of typical document creation software. This ultimately leads to a greater yield of printed results that are satisfactory to the user, with a corresponding reduction in wasted resources and associated costs.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A controller for a printer, accessible using a web browser, configured to:
render an image of at least a portion of a print job, prior to printing, in a format viewable on a web browser;
receive instructions from a user, via a web browser, as to whether or not to proceed with printing of the print job; and
effect printing of the print job in response to receiving an instruction to do SO via the web browser.

2. A controller in accordance with claim 1 and further configured to receive and store information from the user as to whether or not the user wants an image to be rendered by the controller, when the user requests printing, prior to printing.

3. A controller in accordance with claim 1 and further configured to request, via the web browser, instructions from a user as to whether or not to proceed with printing of the print job after rendering the image of at least a portion of the print job.

4. A controller in accordance with claim 1 wherein rendering the image comprises rendering a WYSIWYG image.

5. A controller in accordance with claim 1 wherein the printer further comprises a color management system.

6. A controller in accordance with claim 5 and further configured to manipulate the color management system in response to receiving an instruction from the user via the web browser.

7. A method of proofing a print job, comprising:
providing a printer with a controller configured to be accessible using a web browser;
rendering an image of at least a portion of a print job, prior to printing, in a format viewable on a web browser, using the controller;
receiving instructions from a user, via a web browser, as to whether or not to proceed with printing at least a portion of the print job; and
printing the print job in response to receiving an instruction to do so via the web browser.

8. A method in accordance with claim 7, wherein information from the user is selectively received and stored in the controller, via a web browser, as to whether or not the user wants an image to be rendered by the controller, prior to printing, in response to the user requesting printing.

9. A method in accordance with claim 7, wherein instructions from a user are requested, via a web browser, as to whether or not to proceed with printing the print job after rendering the image of at least a portion of the print job.

10. A method in accordance with claim 7, wherein rendering the image comprises rendering a WYSIWYG image.

11. A method in accordance with claim 7, and further comprising performing color management, using the printer.

12. A method in accordance with claim 11, wherein the color management is performed by the controller, and wherein the color management is performed in response to receiving an instruction from the user via the web browser.

13. A printer comprising:
a housing;
a print mechanism supported in the housing;
a controller coupled to the print mechanism to control the print mechanism; and
a web server coupled to the controller and configured to render a proof image of at least a portion of a print job, prior to printing, in a format viewable on a web browser, to receive instructions from a user, via a web browser, as to whether or not to proceed with printing of the print job, and to effect printing of the print job in response to receiving an instruction to proceed with printing via the web browser.

14. A printer in accordance with claim 13 wherein the web server is further configured to receive and store information from the user as to whether or not the user routinely wants a proof image to be rendered, prior to printing, by the web server.

15. A printer in accordance with claim 13 wherein the web server is further configured to request, via the web browser, instructions from a user as to whether or not to proceed with printing of the print job after rendering the proof image.

16. A printer in accordance with claim 13 wherein rendering the proof image comprises rendering a WYSIWYG image.

17. A printer in accordance with claim 13 wherein the printer further comprises a color management system.

18. A printer in accordance with claim 17 wherein the web server is further configured to effect manipulation of the color management system in response to receiving an instruction from the user via the web browser.

19. A controller for a printer, accessible using a web browser, comprising:
means for rendering an image of at least a portion of a print job, prior to printing, in a format viewable on a web browser;
means for receiving instructions from a user, via a web browser, as to whether or not to proceed with printing of the print job; and
means for effecting printing of the print job in response to receiving an instruction to do so via the web browser.

20. A controller in accordance with claim 19 and further comprising means for receiving and storing information from the user as to whether or not the user wants an image to be rendered by the controller, when the user requests printing, prior to printing.

21. A controller in accordance with claim 19 and further comprising means for requesting, via the web browser, instructions from a user as to whether or not to proceed with printing of the print job after rendering the image of at least a portion of the print job.

22. A controller in accordance with claim 19 wherein the means for rendering an image comprises means for rendering a WYSIWYG image.

23. A controller in accordance with claim 19 wherein the printer further comprises means for managing color.

24. A controller in accordance with claim 23 and further comprising means for manipulating the color management means in response to receiving an instruction from the user via the web browser.
